(19) United States
(12) Patent Application Publication
(10) Pub. No.: US 2026/0338589 A1
(43) Pub. Date: Oct. 29, 2026

(54) CAPACITIVE SENSOR

(71) Applicant: CEBI ELECTROMECHANICAL COMPONENTS SPAIN, S.A., VILLATUERTA (NAVARRA) (ES)

(72) Inventors: SERGIO DÍEZ GARCÍA, VILLATUERTA (NAVARRA) (ES); JAVIER GARCÍA IZAGUIRRE, VILLATUERTA (NAVARRA) (ES); JORGE MACHÍN MINDÁN, VILLATUERTA (NAVARRA) (ES); ENRIQUE BRETÓN CRISTOBAL, VILLATUERTA (NAVARRA) (ES); LESMES NICOLÁS HARO, VILLATUERTA (NAVARRA) (ES)

(21) Appl. No.: 19/646,840

(22) Filed: Apr. 14, 2026

(30) Foreign Application Priority Data
Apr. 23, 2025 (ES) U 202530735

(51) Int. Cl. G01F 23/263

(52) U.S. Cl. CPC G01F 23/266

(57) ABSTRACT

A capacitive sensor (1) for measuring dielectric fluid levels, comprising a metal main body (11) that can be secured to a connector (2) comprising electrical connection terminals (3), forming a chamber (4) which has an electronic circuit board (5), the sensor (1) comprising an inner rod electrode (6) and a hollow outer tubular electrode (7) coaxial with the inner electrode (6), both in electrical connection to said electronic circuit board (5), characterised in that it comprises an insulating internal frame (8) which separates the outer electrode (7) from the inner electrode (6), and the inner electrode (6) from the main body (11).

### CROSS REFERENCE TO RELATED APPLICATION

This Application claims the benefits of priority of Spanish Patent Application No. U202530735, filed on Apr. 23, 2025, the content of which is incorporated herein by reference.

### TECHNICAL FIELD

The present invention relates to a sensor device for measuring oil levels, for example in a transmission, or any other mechanism or machine comprising a wet sump acting as an oil reservoir.

### BACKGROUND OF THE INVENTION

The compressor is usually equipped with a wet sump lubrication system, so it is important to ensure that there is a minimum oil level at all times.

For a long time, the oil level has been checked via a sight glass located at a specific level on the compressor sump, this being a manual process that requires either the user or the maintenance staff to periodically access the compressor just before the system is started up, in order to visually inspect the level of settled oil. In order to avoid said visual inspection, various efforts have been made to carry out said check electronically, without human intervention, using a sensor device, and should the level fall below a minimum, an alert is displayed on a control panel.

The high pressure generated by the compressor during operation makes this task difficult, and using float sensor devices becomes very problematic as they are commonly used for other applications.

To solve this problem, capacitive sensor devices are well-known, which consist of a tubular capacitor within the compressor sump, formed by an outer tubular electrode and an inner rod electrode that are concentric with each other, with a gap between electrodes acting as an electrical capacitor, such that a difference in the dielectric constant arises between the two electrodes when air is present and when oil is present. Said capacitive sensor devices can be configured to form a highly robust sensor unit, enabling them to adapt to significant pressure changes in the compressor.

However, this known solution comprises a tubular electrode made of a monobloc copper alloy with the main body, which requires complex machining, and the inner electrode comprises a sheath made of insulating material covering same, these being characteristics that result in high costs.

In addition, said solution also presents electrical design issues, as the outer tubular electrode is electrically connected to the metal body of the sensor. Thus, for the implementation of the present invention, in which the compressor sump is made of metal, the outer electrode is connected to the potential of the compressor sump, and which may be connected to a ground that may be several volts apart from the internal ground of the sensor circuitry, which would be supplied by a control unit. This potential difference between both grounds, which can amount to several volts, would cause a current that could be high to circulate, at the very least resulting in undesirable parasitic power consumption.

To solve this final problem, known solutions incorporate a high-value resistor in parallel with a capacitor between the two grounds to limit the circulating current, at the same time providing low impedance for alternating current, which is necessary to offer some protection against disturbances that could capacitively couple to the outer metal body of the sensor.

Although the addition of the resistor and capacitor partially solves the problem, from the perspective of the present invention, in which the capacitance between electrodes is converted almost directly into a digital value despite the current being limited, the fact remains that both grounds may be at different potentials, which interferes with the transducer system, possibly resulting in measurement uncertainty and, in the worst case, erroneous readings, and the consequent failure to trigger an alarm or the triggering of unwanted alarms.

### DESCRIPTION OF THE INVENTION

In order to achieve this objective and solve the technical problems discussed so far, as well as to provide additional advantages that may arise in the future, the present invention relates to a capacitive on-off level measuring sensor for detecting dielectric fluid, preferably oil, comprising a main body that can be secured to a connector comprising electrical connection terminals, forming a chamber which has an electronic circuit board, the sensor comprising an inner rod electrode and a hollow outer tubular electrode coaxial with the inner electrode, both in electrical connection to said electronic circuit board, said arrangement of electrodes being structured around an insulating internal frame which separates the outer electrode from the inner electrode and electrically insulates them, both from each other and from the metal body, which, when screwed onto the compressor housing as a plug, acquires the electrical potential of the same as already mentioned.

Given this configuration in which the two electrodes are insulated from each other and from the metal body, a direct voltage could never arise between the two electrodes, as can happen in known solutions; consequently, there is no need for a protective sheath around the inner electrode. In prior art solutions, if the inner electrode were not equipped with said sheath, and if a situation arose in which the oil was contaminated with water and there was a direct voltage between the electrodes due to the potential difference between the grounds, galvanic corrosion could occur; this does not happen in the present invention, even if the sheath is not used, as there is no direct potential between the inner and outer electrodes.

According to an embodiment of the invention, the internal frame consists of a substantially cylindrical bushing made of an electrically insulating material, which is obtained by overmoulding the outer electrode with said insulating material, thereby embedding the outer electrode within said bushing and firmly retaining it therein, having a hole in its centre for inserting the central metal electrode, which will be provided with its sealing means. The outer electrode is thus separated from both the inner electrode and the main body by the walls of the internal frame, in a sandwich-like manner, thus being electrically insulated from the two.

Given this configuration, the metal main body can be insulated in direct current from the ground of the controller, meaning that if there is a potential difference with the local ground, no direct current will circulate between said ground and the body. Furthermore, the metal main body thus insulated can be coupled, as desired, via alternating current to the ground and to the positive supply terminal, which originate from the controller and are present on the electronic circuit board. Said coupling would typically be achieved via a network of capacitors. The metal body thus coupled can act as a Faraday shield or cage, protecting the sensitive circuitry of the section of measure from, for example, radiated interference or capacitive coupling between said metal body and other elements in its surroundings. Similarly, a direct voltage could never be generated between the two electrodes.

According to another feature of the invention, the capacitive sensor comprises a second sealing gasket arranged between the outer electrode and the main body and/or between the outer electrode and the inner electrode.

Preferably, it comprises, at the distal end of the main body, a gasket-compression ring which, when in its secured position, compresses said sealing gaskets to ensure sealing.

According to another feature of the invention, it is envisaged that the capacitive sensor comprises a cap that can be secured to the distal end of the inner electrode, said cap comprising a recess for supporting the outer electrode, thereby providing it with a guide that imparts rigidity, which it lacks as it is preferably a thin-walled piece with longitudinal slots.

According to another feature of the invention, the sensor of the invention comprises at least one inner spring connecting the inner electrode to the electronic circuit board, and at least one outer spring connecting the outer electrode to the electronic circuit board, both springs being coaxial, thereby ensuring electrical contact between said electrodes and the corresponding signal processing circuitry.

In a second alternative embodiment, the main body acts as the outer electrode. For installation thereof, it preferably comprises a securing ring that secures the internal frame to the main body, thereby maintaining electrical insulation between the inner electrode and the outer electrode or main body in this case.

Preferably, in this second embodiment, the sensor comprises a securing ring that secures the internal frame to the main body.

According to another feature of the invention, in the second embodiment, the internal frame will be secured to the main body by welding. This eliminates the need for the aforementioned securing components, while maintaining both electrical insulation and sealing.

According to another feature of the invention, in both embodiments, the sensor comprises a first sealing gasket arranged between the main body and the connector and configured to seal the chamber. This ensures sealing between the medium in which the electrodes are submerged and the outside environment, thereby protecting the electronic circuit board.

Preferably, for the electrical connection of the electronic circuit board to the outer metal body, the electronic circuit board comprises a flexible plate that makes contact. Thus, in the second embodiment, said flexible plate connects the outer electrode to the electronic circuit board.

According to another aspect of the invention, in both embodiments, the outer electrode is made of a plastic material. Preferably, said plastic material is of a type modified with additives that give it sufficiently low volume resistivity to act as the outer electrode of the capacitor it forms with the inner electrode. Even more preferably, the conductive plastic material is modified using carbon black or graphite spheres.

Given this configuration, costs are reduced compared to known solutions that use an outer metal electrode requiring complex machining.

### BRIEF DESCRIPTION OF THE FIGURES

FIG. 1 shows a cross-sectional view of a practical embodiment of the capacitive sensor object of the invention.

FIG. 2 shows a cross-sectional view of an alternative embodiment of the capacitive sensor object of the invention.

FIG. 3 shows a perspective view of the capacitive sensor shown in FIG. 2.

FIG. 4 shows a perspective view of the outer electrode of the practical embodiment shown in FIG. 1.

FIG. 5 shows a perspective view of the outer electrode together with the internal frame.

FIG. 6 shows a cross-sectional view of FIG. 5.

### PREFERRED EMBODIMENT OF THE INVENTION

In view of the mentioned figures and in accordance with the adopted numbering, a preferred exemplary embodiment of the invention may be observed therein, which comprises the parts and elements that are indicated and described in detail below.

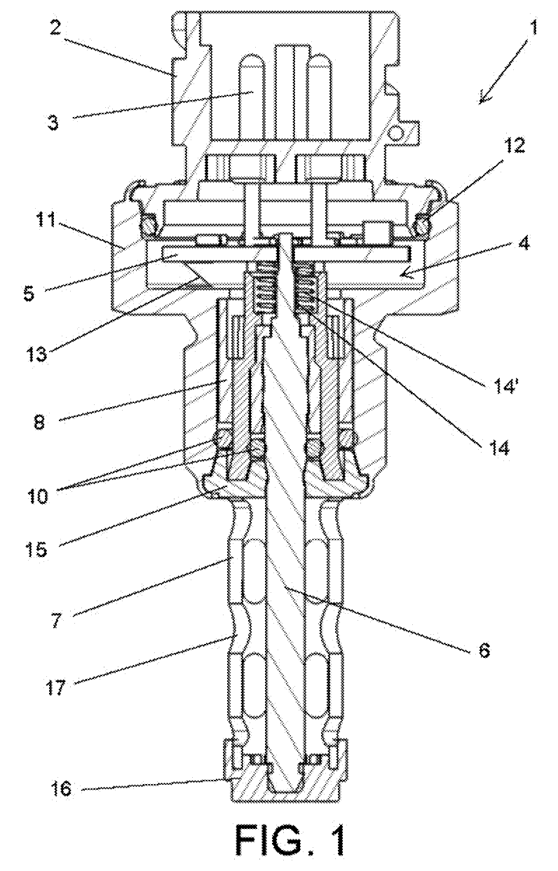

FIG. 1 shows a first practical exemplary embodiment of the capacitive on/off level sensor (1) object of the invention, comprising a connector (2) with connection terminals (3), for securing to a compressor sump, a preferably metal main body (11) being secured to said connector which, at its junction with the connector (2), forms a chamber (4) in which an electronic circuit board (5) is positioned.

As shown in said FIG. 1, said sensor (1) comprises an inner electrode (6) in the form of a rod and an outer electrode (7) in the form of an elongate cylinder, which surrounds said inner electrode (6), both protruding from the main body (11). This leaves a gap between electrodes (6, 7), forming an electrical capacitor, such that when the dielectric constant of the medium filling said gap between the two electrodes (6, 7) changes (as occurs when the medium changes from air to oil and vice versa), the capacitance changes, this change being detected and processed by the electronic circuit board, which then triggers the corresponding alarm.

As shown in FIG. 1, an internal frame (8) is provided inside the main body (11), said frame acting as a spacer between the inner walls of said main body (11) and the inner electrode (6), as well as between the inner (6) and outer (7) electrodes, the three elements thus being electrically insulated from one another. Alternatively, the three pieces are electrically insulated from one another.

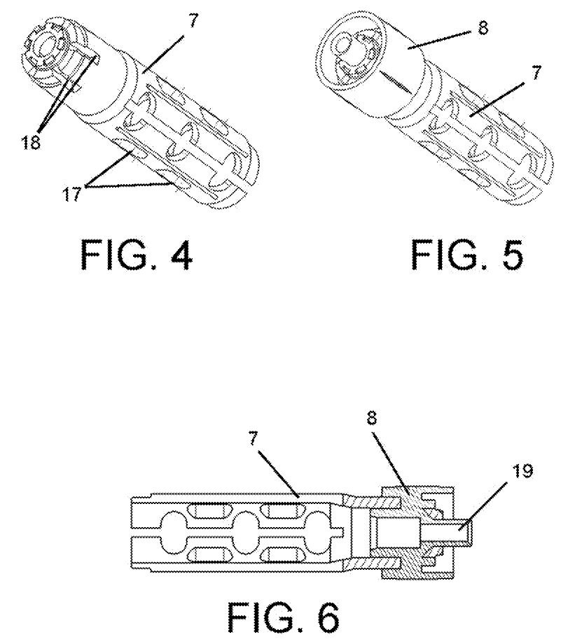

Preferably, the internal frame (8) consists of a bushing made of an electrically insulating material, having a substantially cylindrical shape matching the cylindrical configuration of the outer electrode, such that said internal frame (8) is obtained by overmoulding the outer electrode (7) with said insulating material. As shown in FIG. 4, the outer electrode (7) comprises openings (18) through which the insulating material is inserted, leaving the outer electrode embedded in the internal frame (8) and firmly retained therein, as shown in FIG. 5. Furthermore, the internal frame (8) comprises a central hole (19) for inserting the inner electrode (6), as shown in FIG. 6.

Preferably, said outer electrode (7) is made of a plastic material modified using carbon black or graphite spheres, in order to reduce its electrical volume resistivity to a level suitable for use as a capacitor electrode. It also has a number of holes (17) through which oil can pass.

This prevents the circulation of direct current between any pair of electrodes; and furthermore, by using the metal main body (11) as a Faraday cage, coupled via alternating current to the positive terminal and to the ground of the controller via a network of capacitors, a more accurate measurement is achieved, as it prevents interference or unwanted capacitive coupling between the sensor components and other elements in its surroundings.

To ensure that the chamber (4) containing the electronic components is sealed off from the external environment, it is envisaged that a first sealing gasket (12) is provided at the junction between the connector (2) and the main body (11). Moreover, to ensure that said chamber is sealed off from the pressurised zone or sump of the compressor, it is envisaged that second sealing gaskets (10) are also provided, with one gasket located between the inner electrode (6) and the outer electrode (7), and another gasket between the outer electrode (7) and the main body (11), with both gaskets located below the internal frame (8) according to the vertical arrangement shown in FIG. 1.

Thus, to ensure the correct positioning and proper compression of said second gaskets (10), it preferably comprises a gasket-compression ring (15) that can be secured to the distal end of the main body (11), and which comprises two projections corresponding to the positioning of said gaskets (10). This gasket-compression ring (15) also ensures the positioning of the outer electrode (7) by supporting it.

Furthermore, a cap (16) is secured to the distal end of the inner electrode (6), which comprises a recess into which the outer electrode (7) is fitted. The two electrodes (6, 7) have springs (14, 14’) arranged coaxially at their proximal ends, said springs ensuring electrical contact with the electronic circuit board (5).

In addition, the electronic circuit board (5) comprises a surface-welded plate (13) that facilitates electrical contact with the main body (11), thus establishing coupling via alternating current to the positive terminal and to the ground of the controller via a network of capacitors arranged on the electronic circuit board (5).

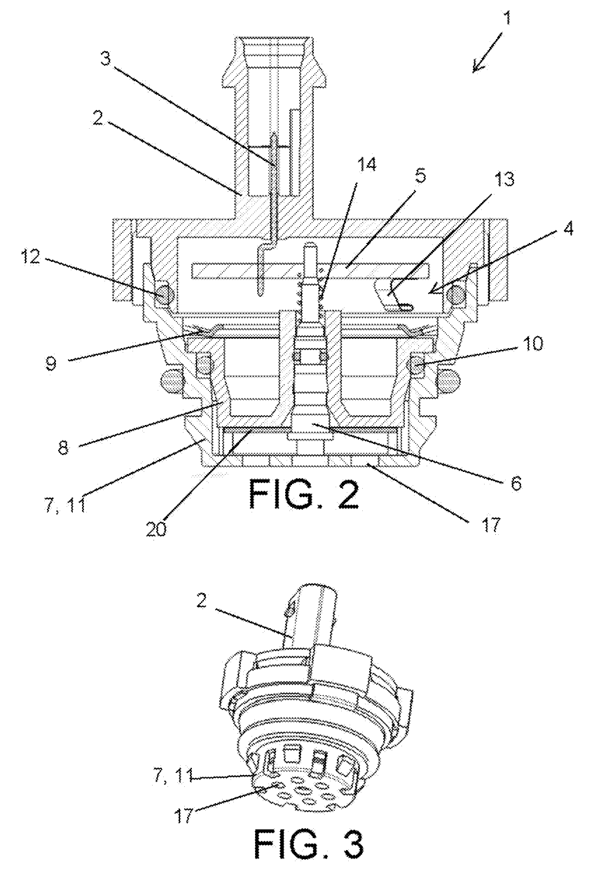

According to a second preferred embodiment, as shown in FIGS. 2 and 3, the inner electrode (6), which is also in the form of a rod, does not protrude from the main body (11) in this case; in this embodiment, said main body (11) serves as the outer electrode (7).

Preferably, said inner electrode (6) comprises a flat disc (20) that is mechanically secured to said rod and in electrical contact with it. This ensures that said inner electrode (6) has a circular surface area equivalent to that of the outer electrode (7) facing said disc (20), thereby correctly forming the capacitor.

The insulating internal frame (8) is cup-shaped, having an inner cylinder with an inner hole into which the inner electrode (6) is fitted, and with the outer wall of the frame in contact with the main body (11), and having a gasket between the internal frame (8) and the inner electrode (6), and a gasket (10) between the internal frame (8) and the main body (11).

A securing ring (9) is provided to secure said internal frame (8), said securing ring coupling to the inner cylinder of the frame (8), securing it to the main body (11).

Similarly, a sealing gasket (12) is also provided to seal the chamber (4) in this case.

Moreover, to allow the oil to pass through, the main body (11) comprises a flat lower surface with holes (17), as shown in FIG. 3.

The inner electrode (6) makes electrical contact with the electronic circuit board (5) via a spring (14), and there is a plate (13) for connecting the outer electrode to the electronic circuit board (5).

The sensor (1) of the practical embodiment shown in FIG. 1 is intended to be secured to the top or side of the sump of the compressor sump, with the electrodes oriented horizontally, while the sensor (1) of the second practical embodiment shown in FIGS. 2 and 3 is intended to be secured to the top of the sump, with the electrodes oriented vertically.

1. A capacitive sensor (1) for measuring dielectric fluid levels comprising: a metal main body (11) secured to a connector (2) comprising electrical connection terminals (3), forming a chamber (4) which has an electronic circuit board (5), an inner rod electrode (6) and a hollow outer tubular electrode (7) coaxial with the inner rod electrode (6), both in electrical connection to said electronic circuit board (5), an insulating internal frame (8) which separates the hollow outer tubular electrode (7) from the inner rod electrode (6), and the inner rod electrode (6) from the metal main body (11).

2. The capacitive sensor (1) according to claim 1, wherein the hollow outer tubular electrode (7) is electrically insulated from the metal main body (11).

3. The capacitive sensor (1) according to claim 1, wherein the insulating internal frame (8) consists of a substantially cylindrical bushing made of insulating material, which is formed by overmoulding the hollow outer tubular electrode (7) with said insulating material, the hollow outer tubular electrode (7) being embedded in said bushing and having a hole in its centre for inserting the inner rod electrode (6).

4. The capacitive sensor (1) according to claim 1, further comprising at least one second sealing gasket (10) between the hollow outer tubular electrode (7) and the metal main body (11) and/or between the hollow outer tubular electrode (7) and the inner rod electrode (6).

5. The capacitive sensor (1) according to claim 4, wherein at a distal end of the metal main body (11), a gasket-compression ring (15), when in a secured position, compresses the at least one second sealing gasket (10) to ensure sealing.

6. The capacitive sensor (1) according to claim 1, further comprising a cap (16) secured to a distal end of the inner rod electrode (6), said cap comprising a recess for supporting the hollow outer tubular electrode (7).

7. The capacitive sensor (1) according to claim 1, further comprising a flexible plate (13) secured to the electronic circuit board (5) and connecting the metal main body (11) to said electronic circuit board (5).

8. The capacitive sensor (1) according to claim 1, further comprising at least one inner spring (14) connecting the inner rod electrode (6) to the electronic circuit board (5), and at least one outer spring (14’) connecting the hollow outer tubular electrode (7) to the electronic circuit board (5), both the at least one inner spring and at least one outer spring (14, 14’) being coaxial.

9. The capacitive sensor (1) according to claim 1, wherein the metal main body (11) is electrically connected to the hollow outer tubular electrode (7).

10. The capacitive sensor (1) according to claim 9, further comprising a securing ring (9) that secures the insulating internal frame (8) to the metal main body (11).

11. The capacitive sensor (1), according to claim 9, wherein the internal frame (8) is secured to the main body (11) by welding.

12. The capacitive sensor (1) according to claim 1, further comprising a first sealing gasket (12) arranged between the metal main body (11) and the connector (2) and configured to seal the chamber (4).

13. The capacitive sensor (1) according to claim 1, further comprising a flexible plate (13) secured to the electronic circuit board (5) and connecting the metal main body (11) to said electronic circuit board (5).

14. The capacitive sensor (1) according to claim 1, wherein the hollow outer tubular electrode (7) is made of a plastic material.

15. The capacitive sensor (1) according to claim 14, wherein the plastic material is modified with additives that give sufficiently low volume resistivity to act as the electrode of a capacitor.

16. The capacitive sensor (1) according to claim 15, wherein the plastic material modified with additives is a conductive plastic material, wherein the conductive plastic material is
further modified using carbon black or graphite spheres.
